(19) United States
(12) Patent Application Publication
(10) Pub. No.: US 2024/0356450 A1
(43) Pub. Date: Oct. 24, 2024

(54) CONVERTER

(71) Applicant: LG INNOTEK CO., LTD., Seoul (KR)

(72) Inventors: Soo San KIM, Seoul (KR); Kwang Soon JUNG, Seoul (KR); Jae Yeop JUNG, Seoul (KR)

(21) Appl. No.: 18/682,192

(22) PCT Filed: Aug. 12, 2022
(86) PCT No.: PCT/KR2022/012074

§ 371 Date: Feb. 8, 2024

(30) Foreign Application Priority Data
Aug. 12, 2021 (KR) 10-2021-0106984

(51) Int. Cl. H02M 3/335; H02M 1/00

(52) U.S. Cl. CPC H02M 3/33573; H02M 1/0009; H02M 3/33515

(57) ABSTRACT

A converter according to one embodiment of the present invention comprises: a converting unit for converting an input voltage into a voltage of a predetermined level; a current sensing unit for sensing an input current of the converting unit; a voltage sensing unit for sensing an output voltage of the converting unit; and a control unit for varying the duty of the converting unit by using the sensed input current and the sensed output voltage.

### TECHNICAL FIELD

The teachings in accordance with exemplary and non-limiting embodiments of this invention relate generally to a converter, and more particularly, to a converter that adaptively compensates for output voltage drops due to load variations.

### BACKGROUND ARTS

A full-bridge converter is a converter that transmits a voltage through a transformer by switching four switching elements complementarily. A phase-shift full-bridge converter is a full-bridge converter that operates with a phase-shift control method, which controls the phase of the switches so that the switching times overlap, increasing the magnitude of the current flowing to the secondary side. This enables zero voltage switching.

If the load connected to the output side of the converter changes rapidly, the output voltage is also affected, and it takes time to change the duty to compensate, making it difficult to react immediately to a sudden drop in output voltage. A technology that can quickly compensate for such output voltage drops is needed.

### DETAILED DESCRIPTION OF INVENTION

### Technical Subject

The technical subject that the present invention seeks to solve is to provide a converter that adaptively compensates for output voltage drops due to load changes.

### Technical Solution

In one general aspect of the present invention, there may be provided a converter, comprising: a converting unit for converting an input voltage into a voltage of a predetermined level; a current sensing unit for sensing an input current of the converting unit; a voltage sensing unit for sensing an output voltage of the converting unit; and a control unit for varying the duty of the converting unit by using the sensed input current and the sensed output voltage.

Preferably, but not necessarily, the duty of a switch included in the converting unit may increase inversely with the magnitude of the output voltage.

Preferably, but not necessarily, the control unit may control a switching operation of the switch included in the converting unit by receiving a first sensing value sensing the input current and a second sensing value sensing the output voltage.

Preferably, but not necessarily, the control unit may sum the first sensed value and the second sensed value and compare them to a reference value to switch off the switch.

Preferably, but not necessarily, the reference value may be set according to the load current.

Preferably, but not necessarily, the control unit may receive the second sensed value as a weighted input.

Preferably, but not necessarily, the control unit may control the switching operation of the switch included in the converting unit in a peak current mode control.

Preferably, but not necessarily, Further, the control unit may control the switching operation of a switch included in the converting unit by the peak current mode control.

Preferably, but not necessarily, the control unit may vary an inclination of a slope for the peak current mode control according to the sensed output voltage.

Preferably, but not necessarily, the control unit may vary the inclination of the slope using digital inclination compensation.

In another general aspect of the present invention, there may be provided a converter, comprising: a switching unit including a plurality of upper switches and a plurality of lower switches in which a phase shift occurs; a transformer that outputs a output voltage of the switching unit to a predetermined level of voltage; and an output-side circuit unit that rectifies and delivers an output signal of the transformer to a load, wherein an amount of time that at least one of the plurality of upper switches and the plurality of lower switches remain in the ON state may be varied depending on the magnitude of the output voltage of the output-side circuit unit.

Preferably, but not necessarily, the switching unit may include mutually and complimentarily conducting first upper switch and first lower switch for comprising a full bridge, and mutually and complimentarily conducting second upper switch and second lower switch for comprising a full bridge, wherein, depending on the magnitude of the output voltage of the output-side circuit unit, the time for which the first upper switch and the second lower switch remain ON simultaneously or the time for which the first lower switch and the second upper switch remain ON simultaneously may increase inversely.

Preferably, but not necessarily, the converter may further include a control unit for controlling the switching operations of the first upper switch, the first lower switch, the second upper switch, and the second lower switch in a peak current mode by measuring an output voltage of the output-side circuit unit and an input current of the switching unit, the control unit being capable of varying an inclination of the slope for controlling the peak current mode according to an output voltage of the output-side circuit unit.

### Advantageous Effect

According to exemplary embodiments of the present invention, it is possible to adaptively compensate for output voltage drops due to changes in load. Thus, the output voltage of the converter can be maintained above the design voltage.

### BRIEF DESCRIPTION OF DRAWINGS

FIG. 1 is a block diagram of a converter according to an exemplary embodiment of the present invention.

FIG. 2 is a block diagram of a converter according to another exemplary embodiment of the present invention.

FIGS. 3 to 10 are drawings to illustrate an output voltage drop compensation process of a converter according to an exemplary embodiment of the present invention.

FIG. 11 is an output voltage drop compensation circuit according to an exemplary embodiment of the present invention.

FIG. 12 is a block diagram of a converter according to another exemplary embodiment of the present invention.

### BEST MODE

Hereinafter, exemplary embodiments of the present invention will be described in detail with reference to the accompanying drawings.

However, the present invention is not limited to the given exemplary embodiments described, but may be implemented in a variety of different forms, and one or more of components among the exemplary embodiments may be used by being optionally combined or substituted between embodiments within the scope of the present invention.

Furthermore, terms (including technical and scientific terms) used in the embodiments of the present invention, unless expressly specifically defined and described, are to be interpreted in the sense in which they would be understood by a person of ordinary skill in the art to which the present invention belongs, and commonly used terms, such as dictionary-defined terms, are to be interpreted in light of their contextual meaning in the relevant art.

Furthermore, the terms used in the embodiments of the invention are intended to describe the embodiments and are not intended to limit the invention.

In this specification, the singular may include the plural unless the context otherwise requires, and references to “at least one (or more) of A and (or) B and C” may include one or more of any combination of A, B, and C that may be assembled.

In addition, the terms first, second, A, B, (a), (b), and the like may be used to describe components of embodiments of the invention. Such terms are intended only to distinguish one component from another, and are not intended to limit the nature or sequence or order of such components by such terms.

Furthermore, when a component is described as “connected,” “coupled,” or “attached” to another component, it can include cases where the component is “connected,” “coupled,” or “attached” to the other component directly, as well as cases where the component is “connected,” “coupled,” or “attached” to another component that is between the component and the other component.

Furthermore, when described as being formed or disposed “above” or “below” each component, “above” or “below” includes not only when two components are in direct contact with each other, but also when one or more other components are formed or disposed between the two components. Furthermore, when expressed as “above” or “below”, it may include the meaning of upward as well as downward with respect to a single component.

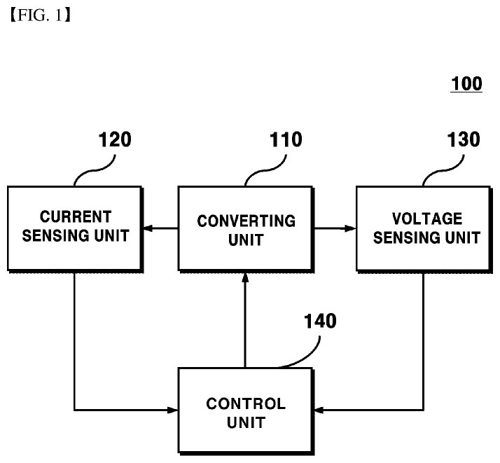

FIG. 1 is a block diagram of a converter according to an exemplary embodiment of the present invention.

The converter (100) according to one embodiment of the present invention may comprise a converting unit (110), a current sensing unit (120), a voltage sensing unit (130), and a control unit (140). The converting unit (110) may convert an input voltage to a predetermined level of voltage.

More specifically, the converting unit may convert the voltage according to an input power source to a predetermined level of voltage and output the same. The converting unit (110) may include one or more switches to convert the voltage, and may include a switching unit (111), a transformer (112), and an output-side circuit unit (113).

The current sensing unit (120) may sense an input current of the converting unit (110), and the voltage sensing unit (130) may sense an output voltage of the converting unit (110). The current sensing unit (120) may be located at the input of the converting unit (110) and may sense an input current into the converting unit (110). A voltage sensing unit (130) may be located at an output of the converting unit (110) to sense an output voltage outputted from the converting unit (110). The control unit (140) may use the sensed input current and the sensed output voltage to vary the duty of the converting unit (110).

More specifically, the control unit (140) may control the duty at which the converting unit (110) operates for the converting operation of the converter. The control unit (140) may use the input current sensed by the current sensing unit (120) and the output voltage sensed by the voltage sensing unit (130) to adaptively and directly reflect changes in the output voltage to vary the duty of the converting unit (110).

The converting unit (110) may include one or more switches, wherein the duty of the converting unit (110) refers to the time that the switches included in the converting unit (110) remain ON. The duty of the converter may mean a rate of operating time per cycle of passing energy from the primary side of the transformer to the secondary side, and the duty of the switch may mean a rate of time per cycle that the switch is ON.

The duty of the switch included in the converting unit (110) may increase inversely with the magnitude of the output voltage. When an output voltage drop occurs that lowers the output voltage due to a change in the load connected to the output of the converting unit (110), the duty of the switch may increase in inverse proportion to the decrease in the magnitude of the output voltage. As the duty increases, the time that the switch included in the converting unit (110) stays ON increases, and as a result, more of the input voltage is delivered to the output side, resulting in a larger output voltage, which can compensate for the output voltage drop caused by the change in load.

Conversely, if the load suddenly becomes smaller, resulting in a larger output voltage, the duty of the switch may be reduced in inverse proportion to the increase in magnitude of the output voltage. As the duty decreases, the time that the switch included in the converting unit (110) remains ON decreases, and as a result, less input voltage is delivered to the output side, resulting in a smaller output voltage, which can compensate for abnormal voltages due to changes in the load.

By using the input current as well as the output voltage information, the control unit (140) can vary the duty by reflecting the change in the output voltage directly on the duty. The process by which the control unit (140) varies the duty will be described in more detail below.

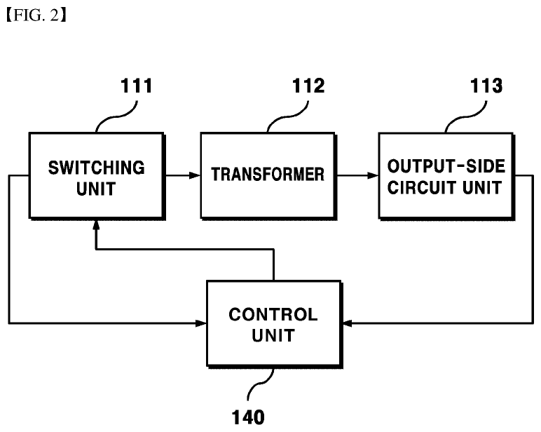

A converter according to an embodiment of the present invention may comprise a switching unit (111), a transformer (112), and an output-side circuit unit (113), as shown in FIG. 2, and may further comprise a control unit (140). Here, the converting unit (110) of FIG. 1 may comprise the switching unit (111), the transformer (112), and the output-side circuit unit (113) of FIG. 2. The switching unit (111) may include a plurality of upper switches and a plurality of lower switches, and may be operated in phase shift.

More specifically, the switching unit (111) may output the input power to the primary side of the transformer (112), but may comprise a plurality of upper switches and a plurality of lower switches for phase-shifting operation. The switching unit (111) may comprise a first upper switch and a first lower switch that are complementarily wired, and a second upper switch and a second lower switch that are complementarily wired to form a full bridge. Here, the first upper switch and the first lower switch, and the second upper switch and the second lower switch may each form a half-bridge, and the two half-bridge circuits may form a full-bridge.

In the absence of operation of phase shift, the first upper switch and the second lower switch may be turned on and off together, and the second upper switch and the first lower switch may be turned on and off together, but phase shift control can be used to create intervals in which the first upper switch and the second upper switch are turned on together, or the first lower switch and the second lower switch are turned on together, allowing more primary current to flow into the secondary side. The converter according to one embodiment of the present invention may be a phase-shifted full-bridge converter.

The switching unit (111) may vary the time for which the first upper switch and the second lower switch remain ON simultaneously, or the time for which the first lower switch and the second upper switch remain ON simultaneously, depending on the current flowing in the load. In the case of including a plurality of upper and lower switches, the time for which the first upper switch and the second lower switch remain ON at the same time or the time for which the first lower switch and the second upper switch remain ON at the same time is the duty. The duty of the converter, that is, the time at which the first upper switch and the second lower switch remain ON at the same time or the first lower switch and the second upper switch remain ON at the same time, is set according to the current to be provided to the load.

The transformer (112) may output the output voltage of the switching unit (111) to a predetermined level of voltage.

More specifically, the transformer (112) may receive the voltage outputted from the switching unit (111) as input to the primary side and outputs it to the secondary side as a voltage at a level depending on the primary side coil and the secondary side winding ratio. The transformer (112) may further include a tertiary side coil to transfer the primary voltage to the second and tertiary sides. The secondary and tertiary sides may have different or equal turns ratios. The output-side circuit unit (113) may rectify the output signal of the transformer (112) and pass the same to the load.

More specifically, the output-side circuit unit (113) may rectify the signal outputted to the secondary of the transformer (112) and pass the same to the load. The output-side circuit unit (113) may comprise a bridge circuit, and may comprise a plurality of diodes or switches. The current flowing through the plurality of diodes or switches is combined and transmitted to the load through an inductor. At the load side, the inductor and an output capacitor forming a rectifying filter may be connected.

The control unit (140) may control the switching operation of the switching unit (111) by inputting the sensed input current and output voltage.

More specifically, the control unit (140) may control the switching operation of the switching unit (111) by receiving input current inputted to the switching unit (111) from the current sensing unit (120) and the voltage sensing unit (130), respectively, and output voltage outputted from the output-side circuit unit (113). At this time, the control unit (140) may control the switching unit (111) in a peak current mode (PCM). In addition, the control unit (140) may control the switching unit (111) via Pulse Width Modulation (PWM), that is, the control unit (140) may control the switching operation of the switching unit (111) by setting a duty of the switch to output a required current to the load, according to the load current, via the peak current mode, and varying the pulse width of the switch to implement that duty.

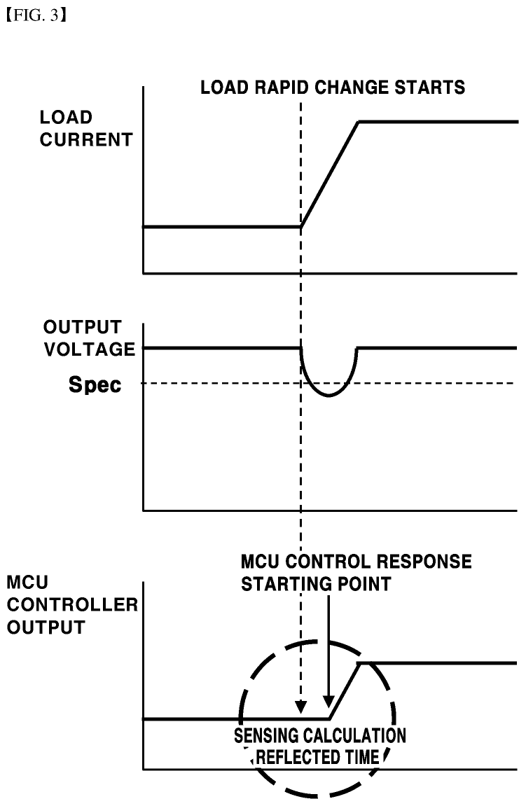

As shown in FIG. 3, the control unit (140), an MCU, may output a control signal for PWM control to implement a duty according to a load current. While the control unit (140) outputs control signals according to a constant load current, if the load changes rapidly and the load current rises, the control unit (140) may need to change the duty according to the changing load current, which requires time to sense the load current and perform the operation to change the duty. At this time, the MCU, which is the control unit (140), may have a delay of two cycles depending on the clock period. Depending on the performance of the control unit (140), there may be a delay of at least one cycle even if the sensing cycle and the calculation cycle are processed in ½ cycle. In other words, since there is a time difference between the time when the load starts to change rapidly and the time when the control unit (140), the MCU, responds to control, if the load current suddenly increases before the MCU's duty control is performed, an output voltage drop may occur in the interim. When an output voltage drop occurs, the output voltage may fall below the design (SPEC) reference output voltage that must be maintained, so that the design voltage cannot be satisfied and, consequently, a problem occurs where the required current to the load cannot be provided sufficiently.

In order to quickly compensate for an output voltage drop due to a change in load, the converter according to an embodiment of the present invention may adaptively vary its duty to reflect a change in the output voltage of the converting unit (110).

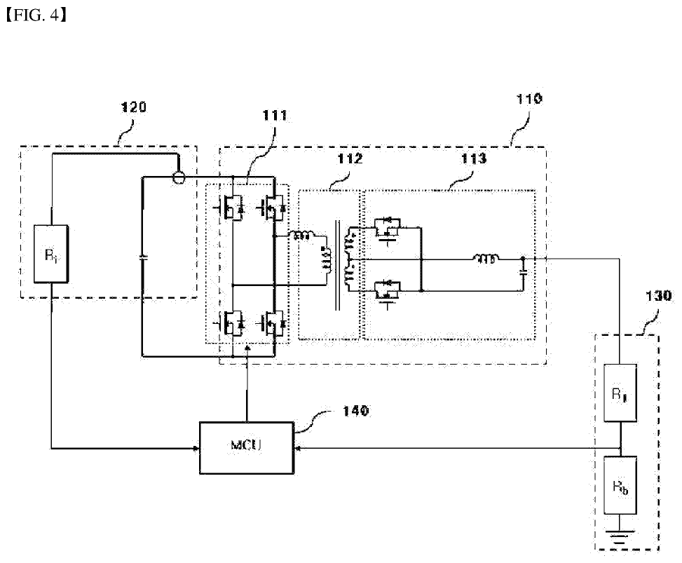

The converter according to an embodiment of the present invention may be implemented as shown in FIG. 4. The control unit (140) may be implemented as a microcontroller, or MCU. In the converting unit (110) comprising the switching unit (111), the transformer (112), and the output-side circuit unit (113), the control unit (140) may measure the output voltage through the voltage sensing unit (130) formed on the output side and measure the input current through the current sensing unit (120) formed on the input side. The control unit (140) may control the switching unit (111) in a peak current mode using the output voltage and the input current.

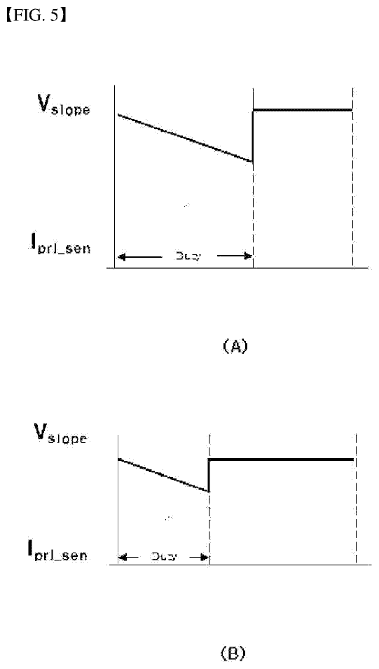

The control unit (140) can control the switching behavior of the switch by setting a slope according to the set duty, turning the switch ON, and then turning the switch OFF when the input current sensed is greater than the slope, as shown in FIG. 5. As shown in FIG. 5(A), when the input current meets the slope late, the duty becomes large, and when the input current meets the slope early, the duty becomes small, as shown in FIG. 5(B). The larger the duty, the more input current that flows to the output. A control signal is inputted to the switch that turns the switch ON by the duty per cycle. Here, the switch can be an FET, and the control 140 can apply a PWM signal based on the duty to the gate of the switch.

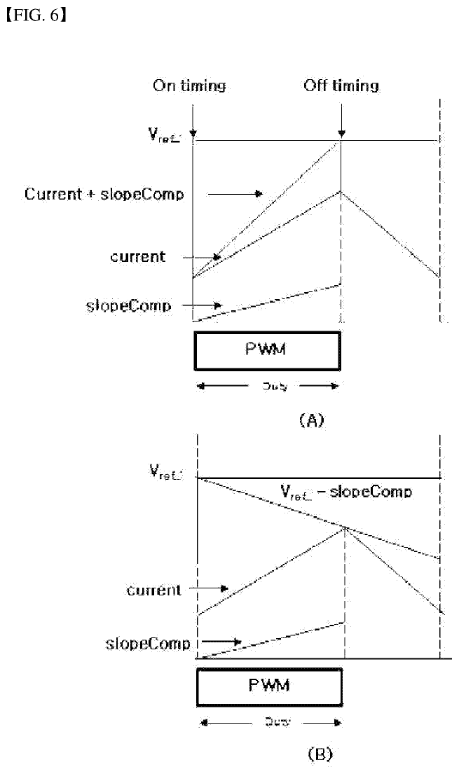

The PWM signal, or duty ratio, can be determined as shown in FIG. 6. FIG. 6(A) is an analogue IC method and FIG. 6(B) is a digital IC method, and the results of both methods are the same.

First, in the analogue IC method, the switch is turned ON every switching cycle and turned OFF when the current plus slope (CURRENT+SLOPECOMP) with a slope applied to the current is greater than the reference value (V_REF_I). PWM signals are generated until the switch turns ON and OFF. The switch is turned OFF when the current+slope (CURRENT+SLOPECOMP) becomes the reference value (V_REF_I), and the duty is formed when the current+slope (CURRENT+SLOPECOMP) at which the switch is turned OFF becomes the reference value (V_REF_I).

In the digital IC method, each switch turns ON every switching cycle and turns OFF when the current is greater than the reference-slope (V_REF_I-SLOPECOMP) with a slope applied to the reference value. A PWM signal is generated until the switch turns ON and OFF. The switch is turned OFF when the current (CURRENT) becomes the threshold-slope (V_REF_I-SLOPECOMP), and the duty is formed when the current (CURRENT) at which the switch is turned OFF becomes the threshold-slope (V_REF_I-SLOPECOMP). The control unit (140) may control the switching unit (111) in peak current mode via a digital IC method (digital slope compensation). Alternatively, an analogue IC method may be used.

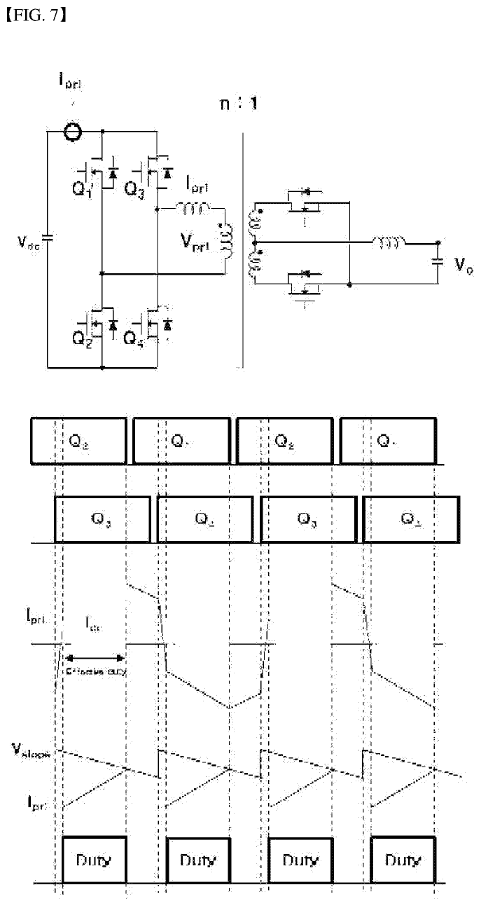

As shown in FIG. 7, the switching unit (111) may comprise a first upper switch (Q1), a first lower switch (Q2), a second upper switch (Q3), and a second lower switch (Q4). In the full-bridge circuit thus formed, duty refers to the time that Q1 and Q4 are ON at the same time, or the time that Q2 and Q3 are ON at the same time. During the duty time, energy is transferred from the primary side of the transformer (112) to the secondary side. The control unit (140) may implement the duty by peak current control, that is, by turning OFF Q2 or Q1 when the input current becomes greater than the slope.

If an output voltage drop occurs due to a change in load, the duty must be changed to compensate for the output voltage drop, but as previously described, it takes time to sense the load current and reset the slope for peak current control according to the sensed load current, so the output voltage drop cannot be compensated quickly, resulting in the output voltage being lower than the threshold voltage.

The control unit (140) may adaptively incorporate changes in the output voltage into the slope, i.e., the slope's inclination (gradient), to compensate for the output voltage drop between the time the output voltage drop occurs and the time it takes to reset the slope.

Hereinafter, the process by which the control unit (140) compensates for the output voltage drop will be described in detail. The control unit (140) can control the switching operation of the switch included in the converting unit (110) by receiving a first sensed (sensing) value of the input current sensed by the current sensing unit (120) and a second sensed value of the output voltage sensed by the voltage sensing unit (130).

At this time, the control unit (140) may sum the first sensing value and the second sensing value and compare them with a reference value to turn off the switch. The control unit (140) may perform peak current control by comparing whether the first sensing value becomes greater than the reference value, wherein the reference value is set by the control unit (140) through sensing and calculation according to the load current, and since time is required for sensing and calculation, the reference value does not immediately reflect changes in the load current. That is, the reference value may be a value set according to the load current at least one cycle earlier. Furthermore, the first sensed value is the primary current of the transformer, which does not reflect changes in the load current. However, the second sensing value is a value that is immediately affected by the change in load current, and the output voltage drop can be quickly compensated by reflecting the second sensing value to the first sensing value and comparing the same to the reference value.

The second sensed (sensing) value can be converted to current and added to the first sensed value. If the load current is stable, the second sense value remains constant and the duty is determined by the change in the first sense value. However, if the load current changes rapidly, the second sensed value also changes, and the duty is determined based on the changes in the first sensed value and the second sensed value. At this time, the control unit (140) may receive the second sensed value as a weighted input. The weighting may vary depending on how much the second sensed value is to be reflected in the first sensed value. The level of reflection of the second sensory value can be adjusted. The weighting may be preset by the user, or may vary depending on the magnitude of the input current or transformation ratio.

The control unit (140) may vary the inclination (gradient) of the slope for peak current mode control based on the output voltage. As previously described, in peak current mode control, a duty is formed at a point where the input current is greater than the slope, and in order to increase the duty to compensate for the output voltage drop, the slope of the slope can be varied, i.e., as the output voltage decreases, the inclination of the slope can be decreased to delay the point at which the input current meets the slope, thereby increasing the duty. In FIG. 6, the inclination of the slope (SLOPECOMP) can be varied to increase the duty by making the inclination smaller.

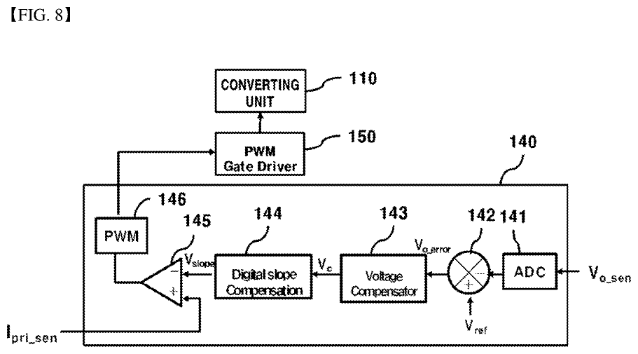

The control unit (140) may vary the inclination of the slope using digital slope compensation. The control unit (140) may comprise an ADC (141), a calculation unit (142), a voltage compensation unit (143), a digital slope compensation unit (144), a comparison unit (145), and a PWM control unit (146), as shown in FIG. 8. The sensed output voltage (V_O_SEN) is received and converted to a digital value by the ADC (ANALOG-DIGITAL CONVERTER) (141), the difference of the reference voltage (V_REF) is calculated, and the result (V_O_ERROR) is inputted to the voltage compensation part (143) to calculate the reference value (V_C) according to the result. The digital slope compensation unit (144) sets the slope (V_SLOPE) to be used to generate the PWM according to that value. Then, by applying the slope to the measured current (I_PRI_SEN) in the comparison unit (145), the PWM control unit (140) can generate a PWM signal until it is equal to the slope. The PWM signal is applied to the gate of the switch of the converting unit (110) via a PWM gate drive unit (150) to control the switch ON and OFF, i.e., generate a PWM signal based on the difference between the load side voltage (V_O_SEN) and the reference voltage (V_REF).

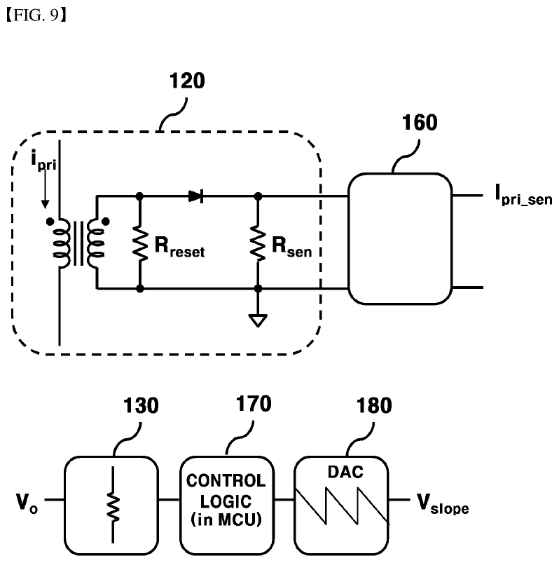

The current sensing unit (120) and voltage sensing unit (130) may be implemented, as shown in FIG. 9. The current sensing unit (120) may comprise a transformer, a resistor, and a diode, and may input an input current signal (I_PRI_SEN) to the control unit (140) through a filter (160). The filter (160) may be implemented as a current control module within the control unit (140). The voltage sensing unit (130) may sense the voltage through resistor distribution, generate it as a digital signal through a voltage control module (170) in the control unit (140), and convert it to an analogue signal for immediate reflection to output a slope (V_SLOPE) reflecting the output voltage change for peak current control. A PWM generation module in the control unit (140) can generate a PWM signal using the input current signal (I_PRI_SEN) and the slope (V_SLOPE) reflecting the output voltage change and output it to the PWM gate driver.

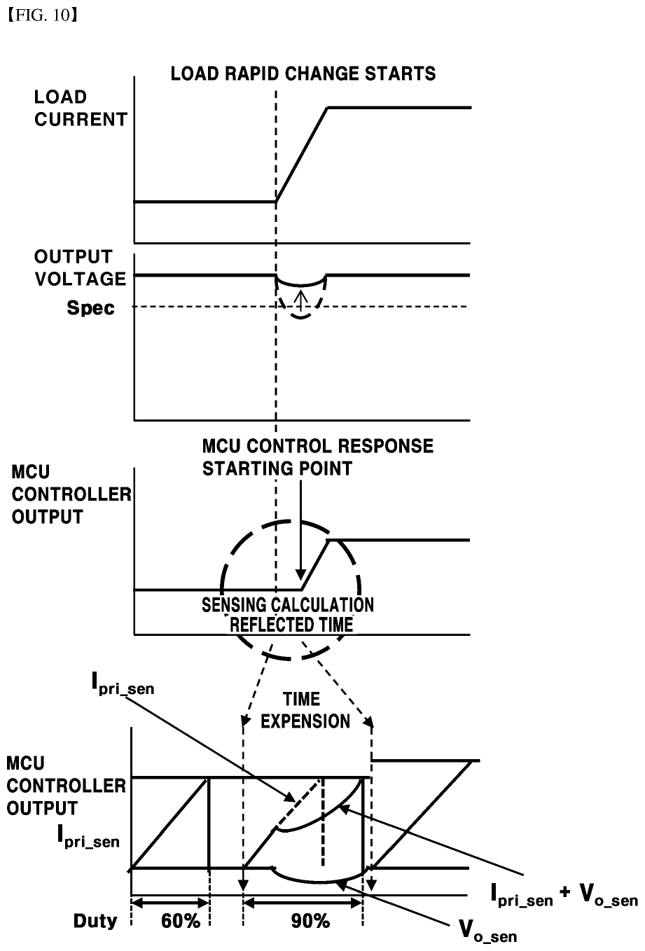

In this way, by reflecting the change in output voltage directly on the slope, the output voltage drop can be compensated immediately without changing the reference value according to the sensing and calculation of the control unit 140. By reflecting the change in output voltage in the inclination of the slope, the duty can be increased without changing the reference value, as shown in FIG. 10. As the output voltage drops when the load begins to change rapidly, the second sensed value (V_O_SEN) of the output voltage is added to the first sensed value (I_PRI_SEN) of the input current compared to the reference value, and the inclination of the slope is varied to increase the duty. For example, the previous duty of 60% may be increased to 90%. Since there is no change in the load after the reference value is reset according to the sensing and calculation of the control unit (140), the second sensing value is also maintained, and the duty is maintained at 90% by comparison of the first sensing value and the reset reference value, so that stable operation is possible.

FIG. 11 is an output voltage drop compensation circuit according to one embodiment of the present invention. In order to compensate for an output voltage drop due to a change in load, the output voltage drop can be compensated without delay by applying a signal of an output voltage to an input current signal sensing an input current and a signal of an output voltage to a control unit, an MCU. Specifically, the output voltage drop compensation circuit according to an embodiment of the present invention includes a transformer sensing the input current, a reset resistor (R_RESET) connected in parallel to the output side of the transformer, a diode connected at one end to the reset resistor and at the other end to a sensing resistor (R_SEN), and a sensing resistor (R_SEN) connected at the other end of the diode.

Furthermore, the output voltage drop compensation circuit may also include a filter resistor (R_FILTER) and a filter capacitor (C_FILTER) connected to the output end connected in series to sense the output voltage, and a feed-forward resistor (R_FF) connected to a terminal between the filter resistor and the filter capacitor and connected at one end to the sensing resistor. The node between the sensing resistor and the feed-forward resistor is connected to the control unit, the MCU, through the filter 160, and the input current signal reflecting the output voltage signal is inputted to the control unit. Since the output voltage signal is reflected in the input current signal and applied to the control unit without separate operation, the duty can be increased by reflecting the output voltage drop without delay.

The filter may be formed by including a low-pass filter resistor (R_LPF) connected at one end to a node between the sensing resistor and the feed-forward resistor, a low-pass filter capacitor (C_LPF) connected to the low-pass filter resistor, two diodes and one resistor (R_1) each connected to a node between the low-pass filter resistor and the low-pass filter capacitor, a voltage source connected to the other end of one of the two diodes, and one capacitor (C_1) connected to the node between the one resistor and the output end of the filter.

For example, R_RESET may be implemented as 10 KΩ, R_SEN may be implemented as 3.3 Ω, R_FF may be implemented as greater than R_SEN depending on the feed-forward level, specifically about 30 times, 100 Ω, R_LPF may be implemented as greater than R_SEN, specifically about 10 times, 4.7 KΩ, C_LPF may be implemented as 1 NF, R_1 may be implemented as 470 Ω, and C_1 may be implemented as 1 NF. It will be appreciated that the implementation circuit of FIG. 11 is only one example for reflecting an output voltage signal to an input current signal, and may be implemented with various other circuits.

A converter according to another exemplary embodiment of the present invention may comprise: a plurality of upper switches and a plurality of lower switches, a switching unit in which a phase shift is operated, a transformer that outputs an output voltage of the switching unit to a predetermined level of voltage, and an output-side circuit unit that rectifies the output signal of the transformer and transmits the same to a load, wherein the time for which at least one of the plurality of upper switches and the plurality of lower switches is switched ON can be varied according to a magnitude of the output voltage of the output-side circuit unit.

The following detailed description of the converter according to another exemplary embodiment of the present invention corresponds to the detailed description of the converter of FIGS. 1 to 11, and redundant descriptions will be omitted.

The switching unit may include a first upper switch and a first lower switch complementarily connected to each other, and a second upper switch and a second lower switch complementarily connected to each other, constituting a full bridge, and the time for which the first upper switch and the second lower switch remain ON simultaneously or the time for which the first lower switch and the second upper switch remain ON simultaneously may increase inversely depending on the magnitude of the output voltage of the output-side circuit unit.

Furthermore, the switching unit may include a control unit for controlling the switching operation of the first upper switch, the first lower switch, the second upper switch, and the second lower switch in a peak current mode by measuring an output voltage of the output-side circuit unit and an input current of the switching unit, the control unit being capable of varying an inclination of the slope for controlling the peak current mode according to an output voltage of the output-side circuit unit.

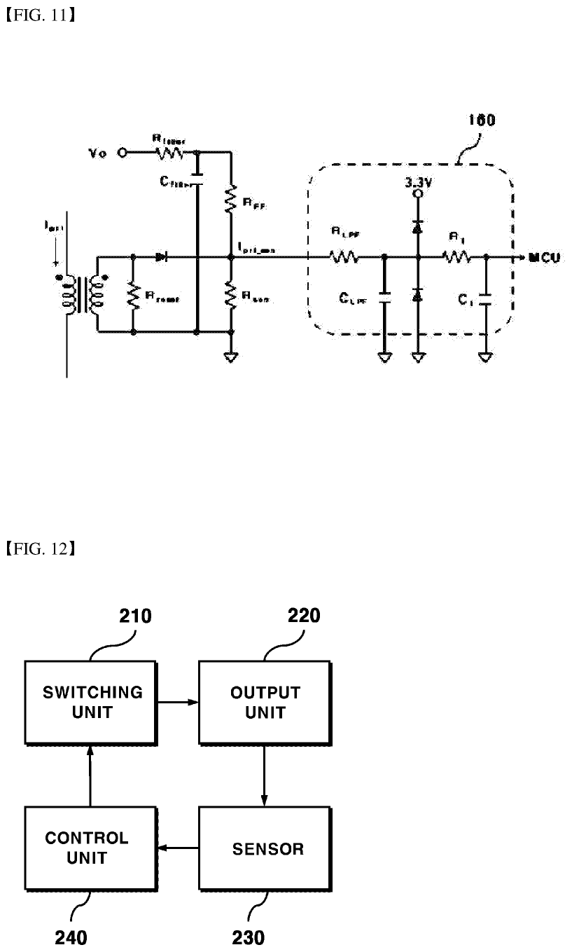

FIG. 12 is a block diagram of a converter according to another exemplary embodiment of the present invention.

A converter according to another exemplary embodiment of the present invention may include a sensor (230) and a control unit (240), and may further include a switching unit (210). Specifically, the converter includes a sensor (230) that senses the state of the output unit (220) and a control unit (240) that controls the switching unit (210) of the full bridge converter, wherein the control unit (240) controls the duty of the switching unit (210) to a first time when the state of the output unit (220) is in a first state, and controls the duty of the switching unit (210) to a second time when the state of the output unit (220) is in a second state, in a Continuous Conduction Mode (CCM).

The detailed description of the converter according to another exemplary embodiment of the present invention will omit redundant descriptions corresponding to the detailed description of the converter of FIGS. 1 to 11.

Here, the switching unit (210) may be a switching unit comprising a first upper switch and a first lower switch, and a second upper switch and a second lower switch, comprising a full bridge, and may be either the first upper switch or the first lower switch. The converter may output the voltage inputted through the operation of the switch to the output unit (220). At this time, the sensor (230) may sense the state of the output unit (220), and the control unit (240) may control the duty of the switching unit (210) according to the state of the output unit (220) sensed by the sensor (230).

The control unit (240) may control the converter to operate in a Continuous Conduction Mode (CCM). Here, the CCM is a mode in which the current in the converter is controlled to flow continuously. The control unit (240) may also control the converter to operate in other modes, such as Discontinuous Conduction Mode (DCM), in addition to the CCM.

The control unit (240) may control the duty of the switching unit (210) for a first time when the state of the output unit (220) is a first state including a load current maintaining state, and a second time when the state of the output unit (220) is a second state including a load current varying state. The first time may be shorter than the second time.

Here, the first and second times may be relative times rather than fixed times. Alternatively, they may be fixed times. The state of the output unit (220) may be detected by sensing a current flowing to the load, or by sensing a value from which the current can be estimated. In the case of the first state, the duty of the switching unit (210) can be controlled by a first time, which is a time that does not reflect the output voltage drop, and in the case of the second state, the duty of the switching unit (210) can be controlled by a second time that does reflect the output voltage drop. Under the condition that an input current is the same, the duty can be controlled by the first time or the second time depending on the state of the output unit (220).

It should be understood that the above description is merely an exemplary description of the technical ideas of the invention, and various modifications and variations will be apparent to one having ordinary skill in the technical field to which the invention belongs without departing from the essential features of the invention. Accordingly, the embodiments disclosed herein are intended to illustrate and not to limit the technical ideas of the invention, and the scope of the technical ideas of the invention is not limited by these embodiments. The scope of protection of the present invention shall be construed in accordance with the following claims, and all technical ideas within the scope of the equivalents shall be construed to be included in the scope of the present invention.

1. A converter, comprising:
a converting unit configured to convert an input voltage into a voltage of a predetermined level;
a current sensing unit configured to sense an input current of the converting unit;
a voltage sensing unit configured to sense an output voltage of the converting unit; and
a control unit configured to vary a duty of the converting unit by using the sensed input current and the sensed output voltage.

2. The converter of claim 1, wherein a duty of a switch comprised in the converting unit increases inversely with a magnitude of the output voltage.

3. The converter of claim 1, wherein the control unit controls a switching operation of a switch comprised in the converting unit by receiving a first sensing value sensing the input current and a second sensing value sensing the output voltage.

4. The converter of claim 3, wherein the control unit sums the first sensing value and the second sensing value and compares the same to a reference value to switch off the switch.

5. The converter of claim 4, wherein the reference value is set according to a load current.

6. The converter of claim 3, wherein the control unit receives the second sensing value as a weighted input.

7. The converter of claim 1, wherein the control unit controls a switching operation of a switch comprised in the converting unit in a peak current mode control.

8. The converter of claim 7, wherein the control unit varies an inclination of a slope for the peak current mode control according to the sensed output voltage.

9. The converter of claim 8, wherein the control unit varies the inclination of the slope using digital inclination compensation.

10. A converter comprising:
a switching unit comprising a plurality of upper switches and a plurality of lower switches and operating a phase shift;
a transformer configured to output a output voltage of the switching unit into a voltage of a predetermined level; and
an output-side circuit unit configured to rectify and deliver an output signal of the transformer to a load,
wherein an amount of time that at least one of the plurality of upper switches and the plurality of lower switches remain in the ON state is varied depending on a magnitude of an output voltage of the output-side circuit unit.

11. The converter of claim 10, wherein the switching unit comprises a first upper switch and a first lower switch complimentarily conducting to each other, and a second upper switch and a second lower switch complimentarily conducting to each other.

12. The converter of claim 11, wherein the first upper switch, the first lower switch, the second upper switch, and the second lower switch form a full bridge.

13. The converter of claim 11, wherein an amount of time that the first upper switch and the second lower switch remain ON simultaneously of an amount of time that the first lower switch and the second upper switch remain ON simultaneously increases inversely with the magnitude of an output voltage of the output-side circuit unit.

14. The converter of claim 11, comprising:
a control unit configured to control switching operations of the first upper switch, the first lower switch, the second upper switch, and the second lower switch in a peak current mode by measuring the output voltage of the output-side circuit unit and an input current of the switching unit.

15. The converter of claim 14, wherein the control unit varies an inclination of a slope for the peak current mode control according to an output voltage of the output-side circuit unit.

16. The converter of claim 15, wherein the control unit varies the inclination of the slope using digital inclination compensation.

17. A converter comprising:
a switching unit comprising a plurality of upper switches and a plurality of lower switches and operating a phase shift;
an output unit configured to output a voltage output from the switching unit;
a sensor configured to sense a state of the output unit; and
a control unit configured to control a duty of the switching unit according to the state of the output unit sensed by the sensor,
wherein the control unit controls the duty of the switching unit as a first time in which the state of the output unit a first state comprising a remaining state of a load current, or as a second time in which the state of the output unit a second state comprising a varying state of a load current.

18. The converter of claim 17, wherein the first time is shorter than the second time.

19. The converter of claim 17, wherein the first time and the second time are variable times.

20. The converter of claim 17, wherein the sensor senses a current flowing a load.
